(19) United States
(12) Patent Application Publication
(10) Pub. No.: US 2018/0234796 A1
(43) Pub. Date: Aug. 16, 2018

(54) Digital Content Output Control in a Physical Environment Based on a User Profile

(71) Applicant: Adobe Systems Incorporated, San Jose, CA (US)

(72) Inventors: Manaswi Saha, College Park, MD (US); Thomas William Randall Jacobs, Cupertino, CA (US); David M. Tompkins, Menlo Park, CA (US); Peter Raymond Fransen, Soquel, CA (US)

(73) Assignee: Adobe Systems Incorporated, San Jose, CA (US)

(21) Appl. No.: 15/430,066

(22) Filed: Feb. 10, 2017

(51) Int. Cl. H04W 4/02; G06Q 30/02

(52) U.S. Cl. CPC H04W 4/023; H04L 67/306; G06Q 30/0267; G06Q 30/0261

(57) ABSTRACT

A digital medium environment is described to control provision of digital content within a physical environment to a mobile device associated with a user. User identification data and position data are received. The position data describes a physical location at which the mobile device is disposed within the physical environment. A user profile is selected based on the user identification data. The user profile describes user online interaction with digital content. Digital content is generated that is personalized based on the selected user profile and the position data. Output is then controlled of the generated digital content to the mobile device.

### BACKGROUND

A beacon is typically implemented as a low powered and low cost device that is usable in conjunction with a mobile device (e.g., mobile phones and wearables) to indicate when the mobile device is located near the beacon. For example, the beacon may be configured as Bluetooth® Low Energy (BLE) device that transmits signals that are received by the mobile device when in close proximity This proximity may then be used by an application of the mobile device that is associated with the beacon to trigger provision of digital content for viewing by a user. Beacons have been used to trigger output of digital content in a variety of different scenarios, such as to support indoor navigation within a store, merchandise offers at music concerts and sports stadiums, and so forth.

Conventional techniques and systems used to implement beacons, however, are typically generic and inflexible. For example, conventional techniques rely on a single application for each system of beacons and corresponding service provider system that provides the digital content to this single application for viewing by a respective user. Accordingly, conventional techniques require the user to manually switch from one application to another each time the user moves within range of different beacons that are tied to different systems, which is redundant and tiresome. Additionally, digital content provided by these systems is typically generic (e.g., generalized) and thus may have little relevancy to the user that receives the digital content. Because of this, a user may typically “opt out” of receiving digital content provided by these conventional techniques and systems, which may involve forgoing use of the application altogether or restricting this digital content from being output by the mobile device.

### SUMMARY

Techniques and systems are described to control output of digital content by a service provider system in a physical environment based on a user profile. In this way, the service provider system may leverage knowledge and insight gained from the user profile as well as a physical environment of the user to provide digital content that has increased likelihood of being of interest to a user. In a digital marketing scenario, for instance, digital content may be generated by a service provider system based on the user profile to include advertisements to promote conversion of goods or services within a physical store. Further, generation of digital content may be restricted based on the user profile, such as to prevent output of the digital content to the user when it is unlikely that the digital content is of interest to the user. As a result, the drawbacks of conventional techniques are overcome that result from provision of generic digital content that may oversaturate and lack relevancy to the user. Further, this increases computational resource consumption efficiency by limiting provision of digital content that is not likely relevant to the user.

In one example, the user profile describes the user's online interaction with digital content. The user's profile, for instance, may describe particular brands and types of digital content, with which, a user has interacted with online, such as webpages, advertisements, and so forth that is modeled using machine learning. This online interaction may also describe conversion by the user of particular goods or services. Therefore, when a mobile device of a user is detected at a particular location within a physical environment, digital content is generated for output by the mobile device of the user that is based at least in part on the user profile and thus has an increased likelihood of being of interest to the user. The user profile may also specify user preferences as to when (e.g., time of day) and how (e.g., mobile phone and not wearable) digital content is to be output. In this way, the generated digital content may have an increased likelihood of being relevant to and desired by the user, which may increase a likelihood of conversion of a good or service when used to control generation and output of digital marketing content.

In another example, the techniques and systems provide a unified platform that may be leveraged across different services to generate the digital content above for provision to the mobile device associated with the user. For example, a service provider system may be configured to accept digital content from a variety of different digital marketing systems in a variety of different forms, e.g., from mobile applications, webpages, notifications, and so forth. This digital content may then be configured for rendering by a single application of the mobile device that is associated with the service provider system. As a result, the single application provides a dynamic interface to render these different forms of digital content from these different sources in real time based on a user's location and profile as described above and without requiring the user to switch between applications as required by conventional techniques. Other examples are also contemplated, including verification and privacy measures used to limit oversaturation of digital content to the user and protect against unauthorized access as further described in the Detailed Description.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ user profile based techniques described herein.

FIG. 2 depicts an example system usable to generate a user profile based on online usage data, physical usage data, and/or user preference data.

FIG. 3 depicts a procedure in an example implementation in which a user profile is generated based on user preferences manually entered by a user as well as based on machine learning applied to data describing online interaction of the user with digital content.

FIG. 4 depicts an example system usable of digital content generation based at least in part of a user profile of FIGS. 2-3.

FIG. 5 depicts an example system showing operation of a digital content generation module of FIG. 4 in greater detail as providing a platform for digital content generation.

FIG. 6 is a flow diagram depicting a procedure in an example implementation of digital content generation for output based at least in part on a physical environment in which the digital content is to be consumed and a user that is to view the content.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

Overview

Beacons are typically employed by a service provider system to provide digital content to a mobile device based on physical proximity of the mobile device to the beacon. For example, an application of a user's mobile phone may output a notification indicating that a particular phone retailer is near while walking through a mall based on proximity of the mobile phone to a beacon associated with the particular phone retailer. As previously described, however, conventional techniques to do so require active execution of a dedicated application that is particular to a service provider system that includes the beacon. Thus, conventional techniques are fractured and frustrating to users as well as consume significant amounts of computational resources to provide generic digital content to each user regardless of whether that digital content is or is not of interest to a user.

Accordingly, digital content output control techniques and systems are described for use in a physical environment based on a user profile. Through use of these techniques, digital content is generated for output that is likely to have increased relevance to a user viewing the content, limits oversaturation in the provision of digital content to the user, and may do so with increased efficiency in the consumption of computational resources by both the service provider system and mobile device of the user.

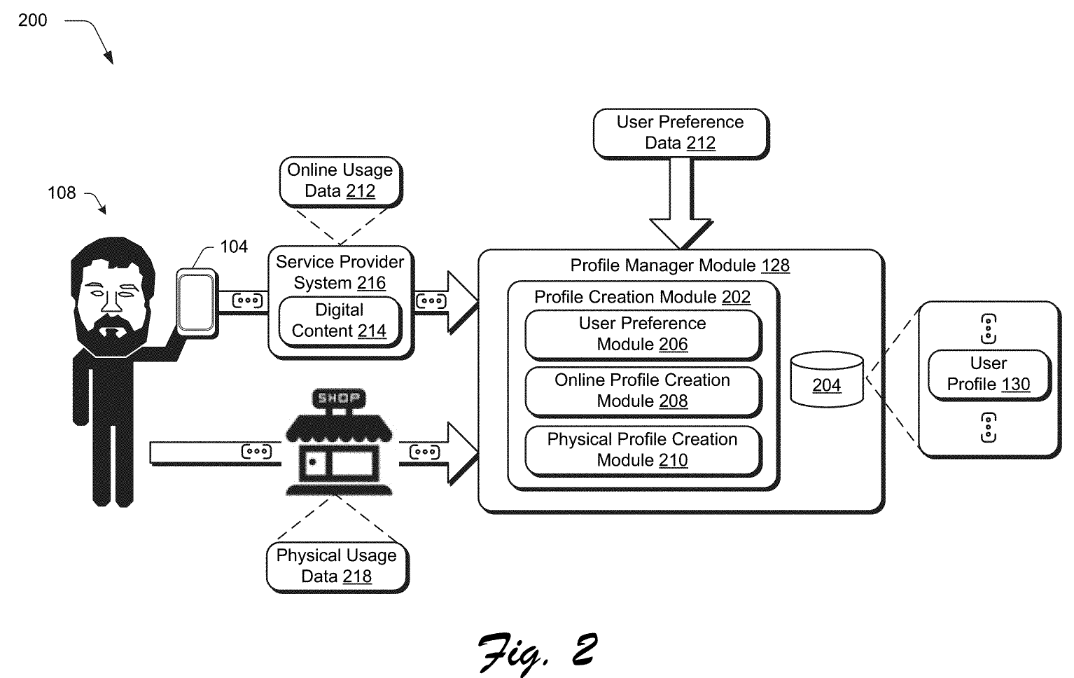

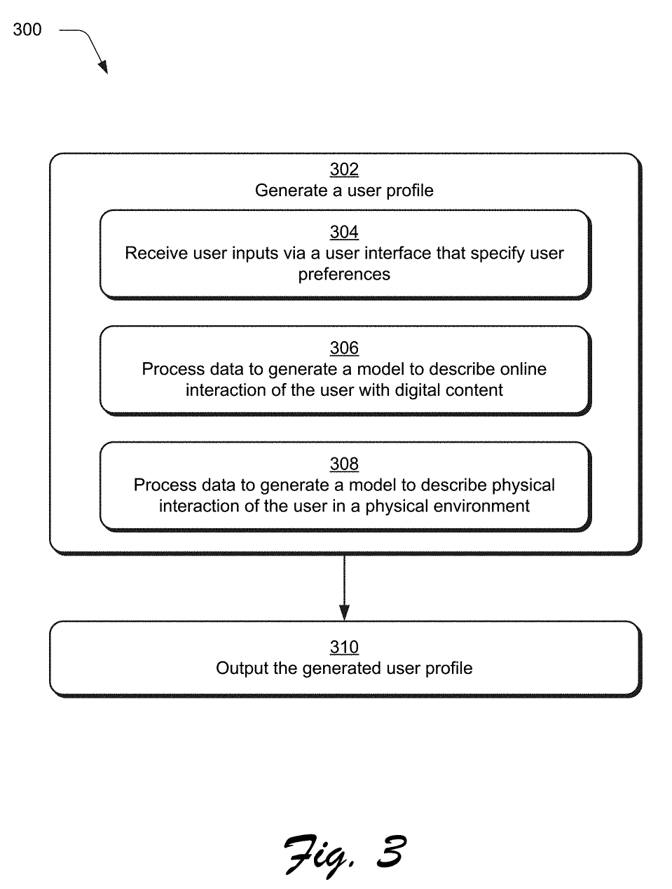

In one example, a user profile is used to control generation of digital content for output to a mobile device associated with a user based on a physical environment in which the mobile device is disposed. The user profile, for instance, may be generated by a service provider system based on user inputs to manually enter user preference, such as a time of day during which output of digital content is preferred by the user, types of digital content that are of interest to the user (e.g., particular sports or activities), and so forth. The user profile may also be generated automatically and without user intervention by a service provider system using machine learning to model online interaction of the user with digital content. This interaction may include which advertisements have been viewed by the user online and resulting conversion of goods or services, digital content with which a user has indicated interest (e.g., via a search query to a search engine), and so forth. A variety of other examples involving generation of the user profile are also contemplated as further described in relation to FIGS. 2 and 3.

Regardless of how the user profile is generated, the service provider system then leverages insight gained from the user profile to provide context-relevant digital content. For example, the user profile may indicate to the service provider system that a user has recently shopped online for camping equipment. The user may then at a later time pick up a mobile phone and visit a mall. When the user is proximal to a physical location in the mall that includes camping equipment (e.g., a particular beacon), the service provider system may cause digital content to be output via the mobile phone (e.g., and related application) that relates to camping equipment, such as digital marketing content that includes a coupon for a camp stove. In this way, insight gained from the user profile as to a user's online interaction may be used to personalize digital content exposed to the user based on a physical environment of the user.

Additionally, the user profile may also be used to restrict generation of digital content to the user that might not be of interest to the user based on the user profile. For example, the service provider system may prevent output of digital content that is associated with a beacon that is not relevant to the user based on the user profile, e.g., digital content that relates to auto parts when the user profile indicates that the user does not own a car and is not interested in cars. In this way, the service provider system may protect against oversaturating the user with digital content that is likely not relevant to the user and reduce computation resources that are consumed by the service provider system and mobile device.

The service provider system may also implement a unified platform to unite different systems of beacons, applications, and digital content together and thus overcome difficulties of conventional systems that involve multiple applications and thus user navigation between these applications. In one example, the service provider system is configured to select a user profile based on user identification data that identifies a particular user and a position profile that describes a characteristic of a position of a mobile device associated with the user, e.g., coordinates, identifies a particular beacon, good or services located proximal to the particular beacon, and so forth.

The user profile and position profile are then used to generate digital content by the service provider system. Digital marketing systems, for instance, may communicate digital marketing content to the service provider system and characteristics to be used as a basis to control output the digital marketing content, e.g., an advertisement and identification of a segment of a user population. The service provider system may then select from this digital marketing content and configure it for output to the mobile device of the user based on the user and position profiles. In this way, digital marketing systems may take advantage of a single service provider system to provide personalized digital content to users based on the user profiles and physical environment in which the mobile device of the user is disposed. Other examples are also contemplated, including verification and privacy measures used to limit oversaturation of digital content to the user and protect against unauthorized access as further described in the following sections.

Term Examples

“Digital content” includes content that is configured to be rendered by a device, such as digital images, digital audio, digital multimedia, and so forth. As such, digital content may take a variety of forms, including digital marketing content including advertisements, banner ads, notifications, and so forth.

A “user profile” describes preferences or modeled interactions of a user. Online interactions include interaction with digital content, e.g., via a network such as webpages, advertisements within applications, and so forth. Physical interactions include a user's interaction with a physical environment, e.g., physical locations and actions performed at those locations.

A “position profile” describes a physical location, at which, a respective beacon is positioned, such as data identifying goods or services disposed proximal to the beacon, identifies a retail establishment at which the beacon is deployed, types of goods or services available, environmental conditions, and so forth.

A “beacon” is typically implemented as a low powered and low cost device that is usable in conjunction with a mobile device (e.g., mobile phones and wearables) to indicate when the mobile device is located near the beacon. For example, the beacon may be configured as Bluetooth® Low Energy (BLE) device that transmits signals that are received by the mobile device when in close proximity

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

Example Environment

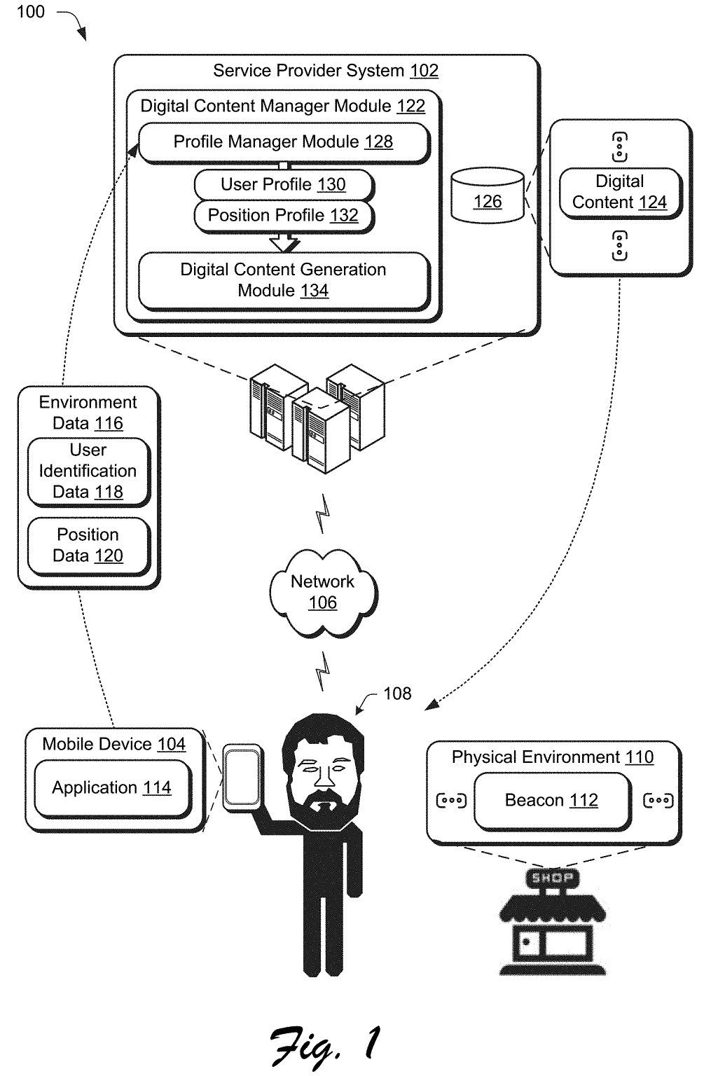

FIG. 1 is an illustration of a digital medium environment 100 in an example implementation that is operable to employ digital content control techniques described herein. The illustrated environment 100 includes a service provider system 102 and a mobile device 104 that are communicatively coupled, one to another, via a network 106. Computing devices that implement the service provider system 102 and mobile device 104 may be configured in a variety of ways.

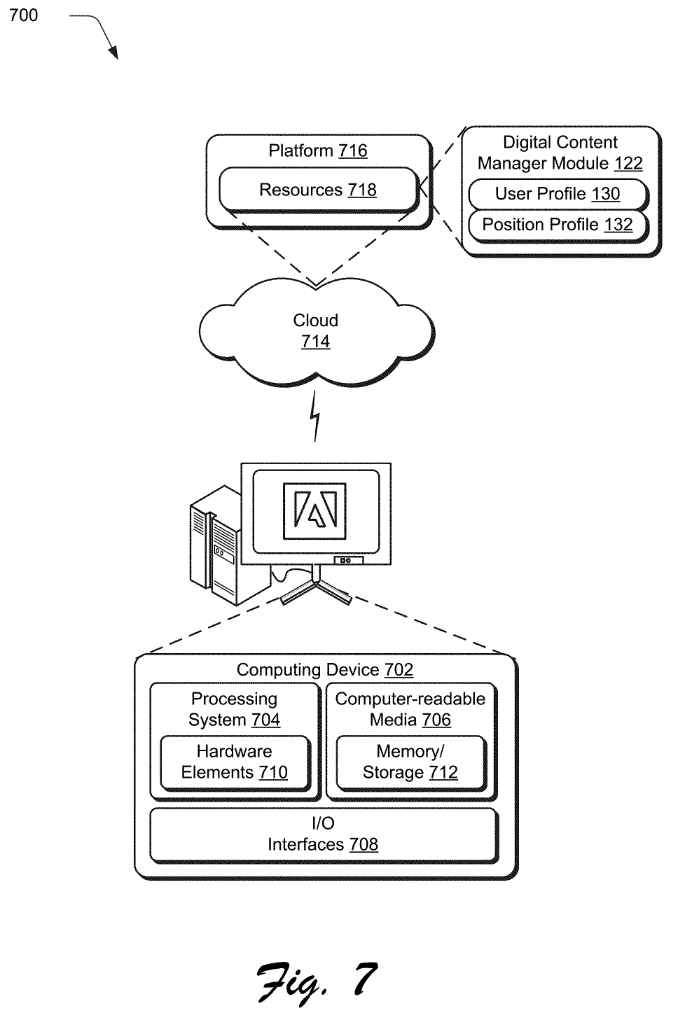

A computing device, for instance, may be configured as a desktop computer, a laptop computer, a mobile device (e.g., assuming a handheld configuration such as a tablet or mobile phone as illustrated), and so forth. Thus, the computing device may range from full resource devices with substantial memory and processor resources (e.g., personal computers, game consoles) to a low-resource device with limited memory and/or processing resources (e.g., mobile devices). Additionally, although a single computing device is shown, the computing device may be representative of a plurality of different devices, such as multiple servers utilized by a business to perform operations “over the cloud” as described in FIG. 7 and as illustrated for the service provider system 102.

The mobile device 104 is illustrated as associated with a user 108 in a physical environment 110. The mobile device 104, for instance, may be configured as a mobile phone, tablet, wearable (e.g., smart watch) or other configuration in which location of the mobile device 104, and thus the user 108, may be tracked within the physical environment 110. In one example, the physical environment 110 includes a beacon 112. As previously described, a beacon 112 is typically implemented as a low powered and low cost device that is usable in conjunction with the mobile device 104 to indicate when the mobile device 104 is located near the beacon. For example, the beacon 112 may be configured as Bluetooth® Low Energy (BLE) device that transmits signals that are received by the mobile device 104 when in close proximity This proximity 104 may then be used by an application 114 of the mobile device 104 that is associated with the beacon 114 and service provider system 102 to trigger provision of digital content for viewing by the user 108 as further described below.

Other examples of determination of a physical location within a physical environment of a mobile device 104 and/or user 108 of the mobile device 104 are also contemplated. In one such example, the mobile device 104 includes a position tracking device (e.g., GPS tracker) that is configured to generate coordinates that include a physical location of the user 108 within the physical environment 110. In another such example, physical location of the mobile device 104 within the physical environment 110 is performed by a series of beacons 112 that implement cameras or other sensors (e.g., RFID tags as the mobile device 104 and sensors as the beacon 112 such as at an amusement park) that are usable to determine location of the user 108.

In the illustrated example, detected proximity of the mobile device 104 to the beacon 112 causes an application 114 of the mobile device to generate environment data 116 for communication via the network 106 to the service provider system 102. The environment data 116, for instance, may include user identification data 118 that is usable to identify the user, such as a login name of the user 108 for an account of the service provider system 102. The user 106, for instance, may download the application 114 and create a user account with the service provider system 102 that includes a login name and password. Accordingly, the login name and/or other credentials of the user 108 may be configured as user identification data 118 to uniquely identify the user 108. In another instance, the user identification data 118 identifies the user 108 as being a member of a segment of a user population and thus does not uniquely identify the user 108, but rather describes characteristics of the segment as a whole, such as demographics, devices employed by the user, and so forth and thus protects privacy of the user.

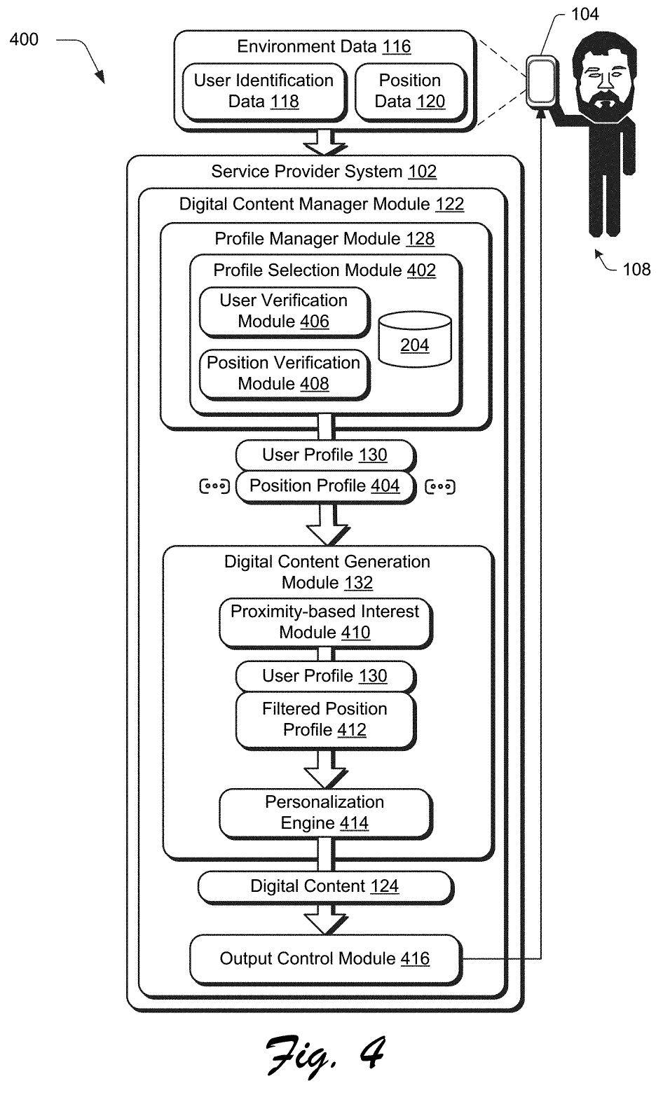

The environment data 116 also includes position data 120. The position data 120 describes a physical location at which the mobile device 104 (and thus the user 108) is disposed within the physical environment 110. The application 114, for instance, may receive a signal and identifying information of the beacon 112 and communicate position data 120 that describes the signal and beacon identification to the service provider system 102. Other examples of position data 120 are also contemplated as further described in relation to FIG. 4, including coordinates.

The environment data 116 as illustrated is then communicated to the service provider system 102. The service provider system 102 includes a digital content manager module 122 that is implemented at least partially in hardware of a computing device to manage creation, storage, and/or communication of digital content 124, which is illustrated as stored in storage 126, e.g., within a computer-readable storage medium as described in relation to FIG. 7. Digital content 124 may take a variety of forms, including digital marketing content (e.g., online advertisements, banner ads), notifications, digital images, digital audio, augmented or virtual reality digital content, and so forth.

As part of management of the digital content 124, the digital content manager module 122 includes a profile manager module 128. The profile manager module 128 is implemented at least partially in hardware of a computing device to select a user profile 130 based on the user identification data 118. The user profile 130 may be configured in a variety of ways. In one example, the user profile 130 is configured to describe user preferences including how and when output of digital content 124 is desired by the user. The user profile 130 may also describe interests of the user 108, which may be manually specified as part of creating the user account with the service provider system 102, learned through machine learning as applied to observed online user interactions, and so forth. Thus, the user profile 130 may provide insight into desires and preferences of the user 108.

The profile manager module 128 is also configured to select a position profile 132 based on the position data 120. The position profile 132, for instance, may describe characteristics associated with a physical location at which the beacon 112 is disposed within the physical environment 110. Examples of characteristics includes semantic information describing a type of good or service available at the physical location (e.g., product data), an identifier of a retail store, and so forth. Thus, the position profile 132 may be used to provide insight into a physical location within a physical environment 110 in which the mobile device 104 and/or user is disposed.

The user profile 130 and the position profile 132, once selected by the profile manager module 128, are then provided to a digital content generation module 134. The digital content generation module 134 is implemented at least partially in hardware of a computing device (e.g., a processing system and computer-readable storage media) to generate digital content 124 based on the user profile 130 and/or position profile 132. The generated digital content 124 may then be output for viewing by the user 108, e.g., via the mobile device 104 or other device such a billboard, as an audio notification, and so forth. In this way, the digital content generation module 134 may leverage insights gained from the user profile 130 and/or position profile 132 to personalize digital content 124 to have an increased likelihood of being of interest to the user 108. This may be used in a variety of scenarios, such as to target digital marketing content in order to increase likelihood of conversion of a good or service and restrict output that is likely not of interest to the user. Further discussion of these and other examples are included in the following sections and shown in corresponding figures.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

User Profile Generation

FIG. 2 depicts an example system 200 usable to generate a user profile based on online usage data, physical usage data, and/or user preference data. FIG. 3 depicts a procedure 300 in an example implementation in which a user profile is generated based on user preferences manually entered by a user as well as machine learning applied to data describing online interaction of the user with digital content.

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In this section, reference is made interchangeably to FIGS. 2-3.

The profile manager module 128 includes a profile creation module 202 that is implemented at least partially in hardware of a computing device to generate a user profile 130 (e.g., illustrated as stored in storage 204) that is to serve as a basis to control output of digital content to the user 108, e.g., via a mobile device 104 associated with the user 108 (block 302). Examples of functionality to do so include a user preference module 206, an online profile creation module 206, and a physical profile creation module 210.

The user preference module 206 is implemented at least partially in hardware of a computing device to receive user inputs via a user interface that specify user preferences (block 304) of the user. The user 108, for instance, may provide user preference data 212 via manual entry through a user interface of the application 114 when configuring a user account of the service provider system 102. The user preference data 212 may describe user preferences regarding how the digital content is desired to be output, e.g., by a particular user device, audio or visual, and so forth.

The user preference data 212 may also describe user preferences regarding when output of the digital content is desired (and consequently also not desired), such as times of day, days of week, seasons, scheduled events (e.g., holidays), and so forth. The user preference data 212 may also describe interests of the user, such as particular subject matter, goods, services, and so forth. Thus, the user preference data 212 may serve as a basis to describe initial preferences of the user, which may also be updated by the user 108 or updated automatically and without user intervention through observed interactions of the user with an online and/or physical environment. In this way, the user 108 is given control as to what digital content is output to the user 108, thereby increasing a likelihood of user participation with the service provider system 102.

The online profile creation module 208 is implemented at least partially in hardware of a computing device to process data to generate a model to describe online interaction of the user with digital content (block 306), e.g., via machine learning such as through neural networks, decision trees, and so forth. The online profile creation module 208, for instance, may receive online usage data 212 that describes interaction of the user 108 via a mobile device 104 or other computing device with digital content 214 of a service provider system 216. For example, the online usage data 212 may describe user interaction with particular websites, digital marketing content, and so forth as well as a result of this interaction, e.g., conversion of a good or service or other user action. From this, the online profile creation module 208 may model user interaction and thus gain insight into user online behavior with may be used to control output of digital content to the user in a physical environment as further described in relation to FIGS. 4-6.

The physical profile creation module 210 is implemented at least partially in hardware of a computing device to process data to generate a model to describe physical interaction of the user 108 in a physical environment (block 306), e.g., via machine learning. The physical profile creation module 210 may employ similar machine learning techniques (e.g., neural networks, decision trees, and so forth) to model physical behavior of the user 108 based on physical usage data 218 that describes interaction of the user 108 with a physical environment. The mobile device 104, for instance, may report locations in a physical environment that are visited by the user 108 as well as interactions with the physical environment and/or mobile device 104 while at those locations.

The physical usage data 218, for instance, may model a time spent at particular locations within the physical environment 110 which may be used as a basis to collect semantic information regarding the locations, e.g., type of goods, services, or activities available at those locations. From this, the physical profile creation module 210 may model user interaction as part of generating the user profile 130 and thus gain insight into user online behavior with may be used to control output of digital content to the user in a physical environment as also further described in relation to FIGS. 4-6. The generated user profile 130 is then output (block 310) to serve as a basis to control output of digital content to the user, such as maintained in storage and used responsive to a request to generate digital content for output to the user 108. An example of which is described in the following section and shown using corresponding figures.

Digital Content Generation

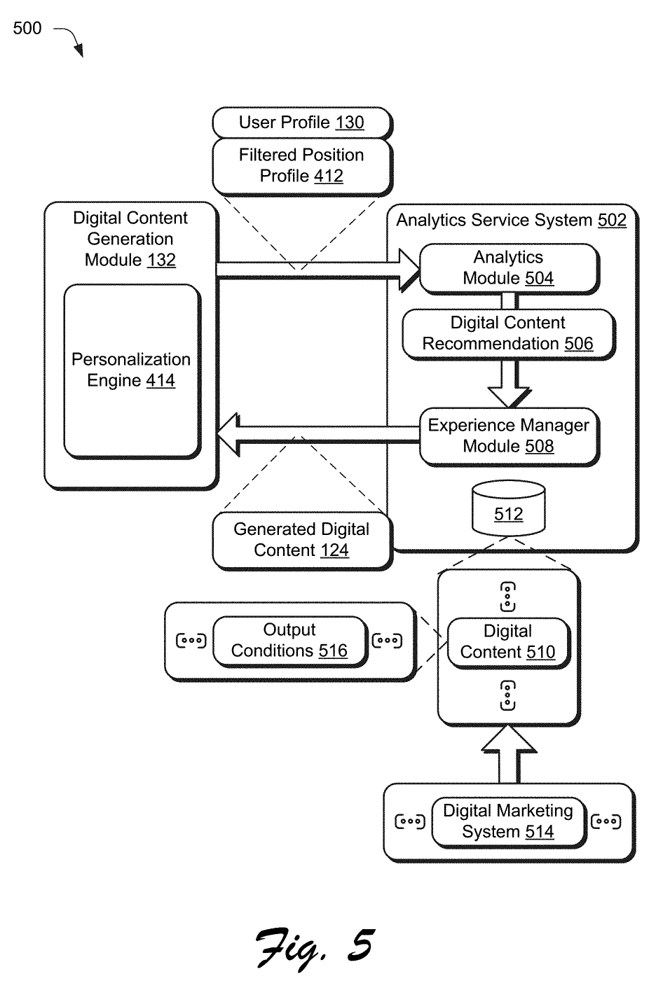

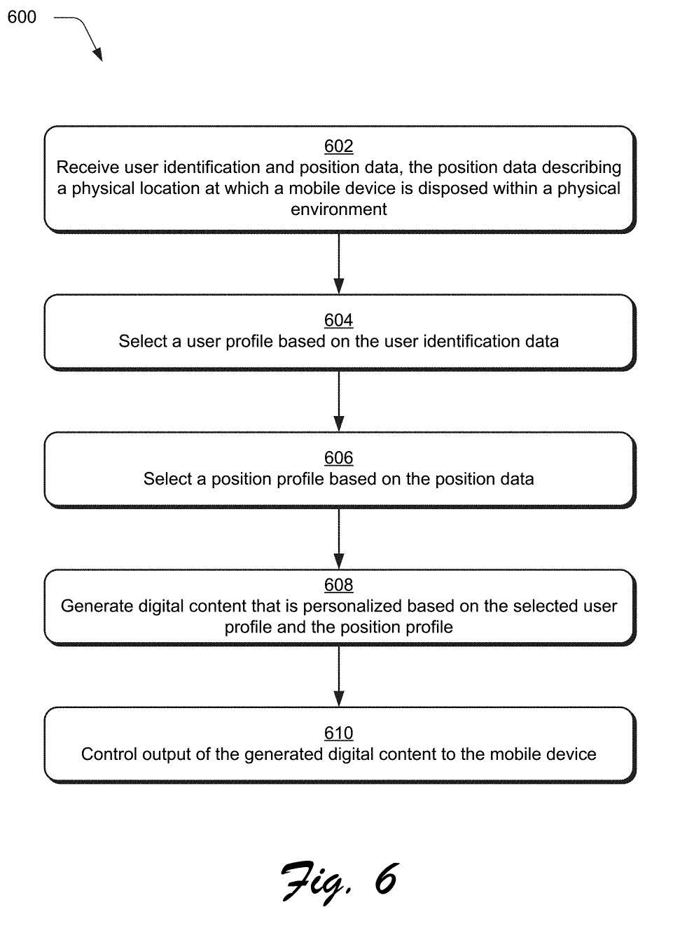

FIG. 4 depicts an example system 400 for digital content generation based at least in part of a user profile 130 generated in relation to FIGS. 2-3. FIG. 5 depicts an example system 500 showing operation of a digital content generation module of FIG. 4 in greater detail as providing a platform for digital content generation. FIG. 6 depicts a procedure 600 in an example implementation of digital content generation for output based at least in part on a physical environment in which the digital content is to be consumed and a user that is to view the content.

The following discussion describes techniques that may be implemented utilizing the previously described systems and devices. Aspects of the procedure may be implemented in hardware, firmware, software, or a combination thereof. The procedure is shown as a set of blocks that specify operations performed by one or more devices and are not necessarily limited to the orders shown for performing the operations by the respective blocks. In this section, reference is made interchangeably to FIGS. 4-6.

To begin, user identification and position data 118, 120 are received (block 602) as part of environment data 116 as previously described in relation to FIG. 1. The position data 118 describes a physical location at which a mobile device 104 is disposed within a physical environment 110, which may be originated in a variety of ways. In one example, the mobile device 104 associated with the user 108 moves within range (e.g., a threshold level of signal strength) of one or more beacons 112 within the physical environment 110. Based on this, the application 114 of the mobile device 104 collects position data 120 which describes a physical location corresponding to the beacons 112 within the physical environment. In one example, the position data 120 includes a signal strength for each beacon 112, sensor data from the beacons, and a beacon identifier usable to differentiate the beacons 112 from each other when multiple beacons 112 are present. In another example, the position data 120 is generated by a position determining device of the mobile device 104, e.g., a GPS device, triangulation through use of cell towers, and so forth. Other computing devices may also be used as part of determining a likely physical location of the user 108 within a physical environment 110, e.g., through use of a camera, RFID sensors and tags, radar technologies, and so forth. Regardless of the origin, the position data 120 is communicated to the service provider system 102 along with user identification data 118. The user identification data 118 is usable to identify the user 108, e.g., uniquely identify the user 108 via user credentials associated with a user account, identify member of the user 108 with a segment of a user population, and so forth.

The profile manager module 128 includes a profile selection module 402 that is implemented at least partially in hardware of a computing device to select a user profile 130 and at least one position profile 404 based on the user identification data 118 and the position data 120, respectively. As part of this selection, the profile selection module 402 employs a user verification module 406 and a position verification module 408 to verify validity of the user identification data 118 and the position data 120, respectively. The user verification module 406, for instance, verifies that the user identification data 118 corresponds to a valid user profile 130 that is available from storage 204. If so, the user verification module 406 selects the user profile 130 based on the user identification data (block 604). If not, the user verification module 406 communicates an error back to the mobile device 104, may flag the user identification data 118 as corresponding to a potentially malicious party, and ceases further digital content generation operations thereby conserving computational resources of the service provider system 102.

Likewise, the position verification module 408 is configured to verify validity of the position data 120. Once verified, at least one position profile is selected based on the position data (block 606). For example, the position verification module 408 may protect against rogue devices from malicious parties by verifying beacon identification included in the position data 120 has a corresponding position profile 404 in storage 204.

Each position profile 404 describes a physical location, at which, a respective beacon is positioned, such as data identifying goods or services disposed proximal to the beacon, identifies a retail establishment at which the beacon is deployed, types of goods or services available, environmental conditions, and so forth. In instances in which multiple beacons 112 are located within range of the mobile device 104, verification is performed for each beacon identification, and if verified, a respective position profile 404 is obtained from storage 204. Thus, each position profile 404 gives insight in a physical location in a physical environment, at which, the user 108 is located.

The selected user profile 130 and position profiles 404 are then output by the profile manger module 128 to the digital content generation module 132. Digital content is then generated by the digital content generation module 132 that is personalized based on the selected user profile and the position profile (block 608). To do so in this example, a proximity-based interest module 410 is first employed to filter the position profiles 404 based on the user profile 130. For example, the proximity-based interest module 410 may compare interests and preferences described in the user profile 130 to characteristics described by the position profiles 404 for the corresponding physical locations within the physical environment. In the previously camping example, for instance, position profiles that do not relate to camping are filtered (i.e., removed by the proximity-based interest module 410) such that filtered position profiles 412 remain that are consistent with potential interests and preferences expressed by the user profile 130.

The proximity-based interest module 410 may then select at least one of these remaining profiles based on proximity to the mobile device 104 of the user 108, e.g., to select the position profile of the closest remaining beacon. In this way, the filter position profile 412 has an increased likelihood of being of interest to the user and may help prevent against oversaturating the user 108 with digital content that might not be of interest. This further improves efficiency in computational resource consumption by the service provider system 102 by reducing generation of digital content that may not be of interest and thus also improves scalability of the system.

The user profile 130 and the filtered position profile 412 are then provided to a personalization engine 414 to personalize generation of digital content 124 for output to the user 108, e.g., via the mobile device 104. This personalization may be performed in a variety of ways, an example of which includes use of a personalization engine 414 as supporting a platform to collect digital content from a variety of different sources that conventionally would have involved use of dedicated system and application. An example of which is described in the following description and shown in a corresponding figure.

FIG. 5 depicts an example system 500 showing operation of a personalization engine 414 of the digital content generation module of FIG. 4 in greater detail as supporting a platform for digital content generation. The personalization engine 414 in this example communicates the user profile 130 and the filtered position profile 412 to an analytics service system 502. In this way, the analytics service system 502 is provided with offline data that gives insight into the user 108, e.g., through user preference data 212, online interaction, and even physical interaction with the physical environment as described in relation to FIGS. 2 and 3.

This data is received by an analytics module 504 of the analytics service system 502 that is implemented at least partially in hardware to employ machine learning (e.g., through use of a neural network) to generate a digital content recommendation 506 based on the insight provided by the user profile 130 and the filtered position profile 412. The analytics module 504, for instance, may model the user interaction, including what items of digital content the user 108 interacted with online and a result of those interactions to form a digital content recommendation 506. This digital content recommendation 506 may also account for characteristics of a physical location, at which, the user 108 is located within a physical environment 110. Thus, the analytics module 504 may employ the user profile 130 and filtered position profile 412 to bridge online interaction of the user 108 with a digital medium environment (e.g., service provider systems via the internet) with physical interaction at physical locations in a physical environment 110.

The digital content recommendation 506 is then employed by an experience manager module 508 as a basis to generate the digital content 124 to be provided back to the user 108. In this example, the analytics service system 502 includes several different items of digital content 510 that are maintained in storage 512. These items of digital content 510 in this example are configured as digital marketing content (e.g., online advertisements, in-app notifications, banner ads) that is received, respectively, from several different digital marketing systems 514. The digital content 510 is received along with output conditions 516 that are specified by respective digital marketing systems 514 for the digital content 510.

A digital marketing system 514 associated with camping gear, for instance, may provide digital content as an offer for purchase of camping gear at a physical location and also specify output conditions 516 that are to be met. These output conditions 516 may specify online interaction of the user along with characteristics of a physical location, at which, the user 108 is located within a physical environment 110. Thus, the digital content recommendation 506 may be used along with these output conditions 516 to generate digital content by the experience manager module 508.

In an implementation, the experience manager 508 also supports functionality to reformat the digital content 510 as part of generating the digital content 124. The user profile 130, for instance, may specify a scenario in which the digital content 124 is to be consumed for output to the user 108. The experience manager module 508, in response, may then reformat the digital content 510 as received by the digital marketing system 514 to generate digital content 124 that is suitable for output to the user, e.g., file type, resolution, and so forth. In this way, digital marketing system 514 may provide digital content 510 to the analytics service system in an original form, thereby increasing efficiency and convenience to the digital marketing system 514 as a unified platform.

As a result, disparate digital marketing systems 514 are encouraged to participate as part of a single unified system and associated application 114 and thus may avoid use of dedicated applications as required by conventional techniques and systems. Although digital marketing content has been described in this example, the digital content 510 and use as a unified platform may also be leveraged in a variety of other examples, such as for directions to a particular good or service within a city or mall. Output of the generated digital content is controlled to the mobile device (block 610), such as to a mobile device 104 associated with the user, use of output devices disposed at a physical location of the user 108 (e.g., audio systems, billboards), and so forth.

Example System and Device

FIG. 7 illustrates an example system generally at 700 that includes an example computing device 702 that is representative of one or more computing systems and/or devices that may implement the various techniques described herein. This is illustrated through inclusion of the digital content manager module 122 and user and position profiles 130, 132. The computing device 702 may be, for example, a server of a service provider, a device associated with a client (e.g., a mobile device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to control provision of digital content within a physical environment to a mobile device associated with a user, a method implemented by at least one computing device, the method comprising:
receiving, by the at least one computing device: user identification data and position data, the position data describing a physical location at which the mobile device is disposed within the physical environment;
selecting, by the at least one computing device, a user profile based on the user identification data, the user profile describing user online interaction with digital content;
generating, by the at least one computing device, digital content that is personalized based on the selected user profile and the position data; and
controlling, by the at least one computing device, output of the generated digital content to the mobile device.

2. The method as described in claim 1, wherein the position data describes a physical coordinate within the physical environment or identifies a beacon included within the physical environment.

3. The method as described in claim 1, further comprising selecting, by the at least one computing device, a position profile based on the position data and wherein the generating is based at least in part on the selected user profile and the selected position profile.

4. The method as described in claim 1:
further comprising obtaining, by the at least one computing device, a plurality of position profiles based on the position data,
wherein the generating includes filtering the plurality of position profiles; and
each position profile of the plurality of position profiles corresponds to a respective beacon of a plurality of said beacons disposed within the physical environment that is used at last in part to originate the position data.

5. The method as described in claim 4, wherein the filtering of the plurality of position profiles is based at least in part on the user profile.

6. The method as described in claim 4, wherein the filtering of the plurality of position profiles is based at least in part on a physical proximity of the mobile device to respective beacons of the plurality of said beacons.

7. The method as described in claim 1, wherein the digital content is digital marketing content and the generating is performed to increase a likelihood of conversion of a good or service.

8. The method as described in claim 7, wherein the good or service is disposed proximal to the location in the physical environment.

9. The method as described in claim 1, further comprising verifying, by the at least one computing device, validity of the user data and the position data.

10. The method as described in claim 1, wherein the user profile describes at least one preference regarding when the digital content is to be consumed using the mobile device or how the digital content is to be consumed using the mobile device.

11. The method as described in claim 1, wherein the plurality of coordinates originates from a position determining device of the mobile device associated with the user and the controlling causes communication of the selected item of the digital content for output by the mobile device.

12. The method as described in claim 1, wherein the generating of the digital content includes:
forming a digital content recommendation based on machine learning through use of the user profile; and
configuring the digital content based on the digital content recommendation and a configuration of the mobile device.

13. In a digital medium environment to control provision of digital content to a user within a physical environment, a system comprising:
a profile selection module implemented at least partially in hardware of at least one computing device to select a user profile based on user identification data, the user profile describing user online interaction with digital content of a service provider system; and
a digital content generation module implemented at least partially in hardware of the at least one computing device to generate digital content, the digital content generation module including:
a proximity-based interest module to filter, based on the selected user profile, a position profile from a plurality of position profiles in which each said position profile describes a respective physical location within the physical environment; and
a personalization engine to generate the digital content as personalized based on the filtered position profile and the selected user profile.

14. The system as described in claim 13, further comprising an output control module implemented at least partially in hardware of the at least one computing device to control output of the generated digital content to the user.

15. The system as described in claim 13, wherein the proximity-based interest module is configured to filter the position data based on at least one preference described by the user profile.

16. The system as described in claim 15, wherein the at least one preference specifies when digital content is to be consumed or how digital content is to be consumed.

17. The system as described in claim 13, wherein each position profile of the plurality of position profiles corresponds to a respective one of a plurality of beacons located within the physical environment.

18. In a digital medium environment to control provision of digital content within a physical environment, a system comprising:
means for selecting a user profile based on user identification data, the user profile describing user online interaction with digital content;
means for select a position profile based on position data describing a physical location at which the mobile device is disposed within the physical environment; and
means for generating digital content that is personalized based on the selected user profile and the position data.

19. The system as described in claim 18, wherein the digital content is digital marketing content.

20. The system as described in claim 18, wherein the position data identifies a particular beacon from a plurality of beacons.
